(19) United States
(12) Patent Application Publication
(10) Pub. No.: US 2009/0297368 A1
(43) Pub. Date: Dec. 3, 2009

(54) Single Piece Water Over Air Intercooler for a Reciprocating Air Compressor

(75) Inventors: Steven Knox, Pittsburgh, PA (US); Matthew D. Mitsch, Pittsburgh, PA (US)

Correspondence Address: THE WEBB LAW FIRM, P.C., 700 KOPPERS BUILDING, 436 SEVENTH AVENUE, PITTSBURGH, PA, 15219, US

(73) Assignee: WABTEC HOLDING CORP., Wilmerding, PA (US)

(21) Appl. No.: 12/132,217

(22) Filed: Jun. 3, 2008

(51) Int. Cl. F04B 53/08; F01P 9/00; F04B 25/00; B23P 15/26; F28D 15/00

(52) U.S. Cl. 417/243; 123/41.3; 165/104.13; 417/254; 29/890.035

(57) ABSTRACT

A water over air intercooler for use in a reciprocating air compressor includes a central core unit having an interior which contains a plurality of air passage tubes, a cooling water inlet and at least one cooling water outlet. A first manifold has at least one air inlet and is in communication with the plurality of air passage tubes so as to receive air from the at least one air inlet and direct the air to the plurality of air passage tubes. A second manifold has an air outlet and is in communication with the plurality of air passage tubes so as to receive air from the plurality of finned air passage tubes and direct the air to the at least one air outlet. The central core unit, the first manifold and the second manifold are integrally connected by welding to form a single piece.

### BACKGROUND OF THE INVENTION

1. Field of the Invention

The present invention relates to a single piece water over air intercooler for cooling compressed air in a reciprocating air compressor. More specifically, the present invention relates to a water over air intercooler having a central core unit containing a plurality of air passage tubes, first and second manifolds, as well as air inlets and outlets and cooling water inlets and outlets all welded together to form a unitary construction. Air from a first stage of compression is directed into the intercooler where it is cooled by cooling water from an engine cooling water flowing over multiple air passage tubes. The cooled air is then directed from the intercooler to a second stage of compression.

2. Description of Related Art

Multi-stage air compressors are known generally in the art for purposes such as providing compressed air for air brake systems in large vehicles and/or locomotives. One such compressor is disclosed in U.S. Pat. No. 5,106,270 to Goettel et al., which is hereby incorporated by reference in its entirety. As can be appreciated by one of ordinary skill in the art, pressurizing air to the level necessary for use in air brake systems also results in a large increase in the temperature of the air within the compression system, which leads to breakdown of lubricating oils within the brake system and damage to the braking devices. It is advantageous, then, to provide cooling devices within such compressors between the compression cylinders in order to lower the ambient temperature of the compressed air to suitable levels.

Intercoolers have been known to utilize an engine's cooling water supply to lower the ambient temperature of the air between compression stages within the compressor. However, prior art designs utilize multiple components that are fastened together by bolts and gaskets. Such designs rely on the gaskets and bolts to seal the various connections within the intercooler to prevent leakage of air or water and to prevent water and compressed air from mixing. However, sealing with gaskets is imperfect and leakage in such prior art intercoolers is a common failure mode as there are a great many potential leakage paths.

Also, these designs require many bolted connections, resulting in a complex design having many separate parts that requires a large amount of labor to produce. Further, such prior art intercoolers are constructed from cast iron, which leads to the intercoolers being heavy and unwieldy as well as difficult to replace.

Accordingly, there is a general need for a single piece water over air intercooler that foregoes bolt and gasket connections in favor of welded connections, which reduces potential leakage paths, reduces the leakage of air from the intercooler as well as the mixing of compressed air and cooling water, reduces overall assembly time and provides a lightweight alternative to prior art intercoolers for use in new compressor assemblies as well as a replacement part for existing intercoolers.

### SUMMARY OF THE INVENTION

It is an object of the present invention to provide a water over air intercooler that uses weld connections rather than bolts and gaskets to fasten components into a single piece, unitary construction.

It is an object of the present invention to provide an intercooler that reduces potential leakage paths and reduces the leakage of compressed air from the intercooler and the mixing of air and cooling water in comparison with prior art intercoolers.

It is an object of the present invention to provide an intercooler constructed from aluminum components so as to reduce weight and make the intercooler easier to handle, install and maintain.

It is an object of the present invention to provide an intercooler having a central core unit that receives compressed air in a plurality of air passage tubes and cooling water from an engine's cooling water supply such that the water flows over the air passage tubes in order to cool the compressed air within the tubes.

It is an object of the present invention to provide an intercooler that retains common interface positions so that the intercooler can be bolted directly into existing compressors of various types as a replacement part.

It is an object of the present invention to provide a reciprocating air compressor having multiple compressor cylinders in multiple stages of compression and a single piece intercooler for cooling compressed air between compression stages.

It is an object of the present invention to provide a method for producing a single piece water over air intercooler that utilizes welded connections to reduce potential leakage paths and reduce the leakage of compressed air from the intercooler and the mixing of compressed air and cooling water.

According to an embodiment of the present invention, a water over air intercooler for use in a reciprocating air compressor is provided. The water over air intercooler includes a central core unit, the central core unit having opposing first and second sides, opposing third and fourth sides and opposing fifth and sixth sides, the sides being integrally connected to define an interior within the central core unit, the central core unit containing a plurality of air passage tubes within the interior, the central core unit having at least one cooling water inlet and at least one cooling water outlet disposed thereon; a first manifold disposed on the first side of the central core unit, the first manifold having at least one air inlet disposed thereon, the first manifold being in communication with the plurality of air passage tubes so as to receive air from the at least one air inlet and direct the air to the plurality of air passage tubes; and a second manifold disposed on the second side of the central core unit, the second manifold having at least one air outlet disposed thereon, the second manifold being in communication with the plurality of air passage tubes so as to receive air from the plurality of finned air passage tubes and direct the air to the at least one air outlet. The central core unit, the first manifold and the second manifold are integrally connected by welding to form a single piece.

The at least one cooling water inlet is integrally connected by welding to the central core unit proximal to the first side of the central core unit, the at least one cooling water inlet being in communication with the interior of the central core unit, and the at least one cooling water outlet is integrally connected by welding to the central core unit proximal to the second side of the central core unit, the at least one cooling water outlet being in communication with the interior of the central core unit.

The interior of the central core unit is adapted to receive cooling water from a supply via the at least one cooling water inlet and return the cooling water to the supply via the at least one cooling water outlet such that the cooling water flows through the interior of the central core unit so as to pass over the plurality of air passage tubes. Air passes from the first manifold to the second manifold via the plurality of air passage tubes within the interior of the central core unit so as to be cooled by the water flowing through the interior of the central core unit and passing over the plurality of air passage tubes. Preferably, the cooling water supply is an engine cooling water supply and the central core unit, the first manifold and the second manifold are constructed from aluminum.

The at least one air inlet is adapted to receive compressed air from a first stage of compression. The at least one air inlet includes an inlet conduit integrally connected by welding to the first manifold, the inlet conduit being in communication with an interior portion of the first manifold, and an inlet mounting plate integrally connected by welding to the inlet conduit. Preferably, the inlet conduit and the inlet mounting plate are constructed from aluminum and the at least one air inlet includes two air inlets.

The first manifold has a width greater than a width of the central core unit such that the first manifold extends along the first side past the third and fourth sides of the central core unit, whereby a surface of the first manifold oriented toward the central core unit has exposed portions adjacent to each of the third and fourth sides of the central core unit, and the air inlets are disposed on the surface of the first manifold such that the inlet conduits are each integrally connected to an exposed portion of the surface of the first manifold adjacent to each of the third and fourth sides of the central core unit.

The at least one air outlet is adapted to direct compressed air to a second stage of compression. The at least one air outlet includes an outlet conduit integrally connected by welding to the second manifold, the outlet conduit being in communication with an interior portion of the second manifold, and an outlet mounting plate integrally connected by welding to the outlet conduit. Preferably, the outlet conduit and the outlet mounting plate are constructed from aluminum. The second manifold includes a raised central portion, the outlet conduit being integrally connected to the raised central portion of the second manifold.

According to a further embodiment of the present invention, a reciprocating air compressor having multiple stages of compression is provided. The reciprocating air compressor includes at least one low-pressure compression cylinder in a first stage of compression, at least one high-pressure compression cylinder in a second stage of compression, and a water over air intercooler in communication with the at least one low-pressure compression cylinder and the at least one high-pressure compression cylinder. The intercooler includes a central core unit, the central core unit having opposing first and second sides, opposing third and fourth sides and opposing fifth and sixth sides, the sides being integrally connected to define an interior within the central core unit, the central core unit containing a plurality of air passage tubes within the interior, the central core unit having at least one cooling water inlet and at least one cooling water outlet disposed thereon, a first manifold disposed on the first side of the central core unit, the first manifold having at least one air inlet disposed thereon, the first manifold being in communication with the plurality of air passage tubes so as to receive air from the at least one air inlet and direct the air to the plurality of air passage tubes, and a second manifold disposed on the second side of the central core unit, the second manifold having at least one air outlet disposed thereon, the second manifold being in communication with the plurality of air passage tubes so as to receive air from the plurality of finned air passage tubes and direct the air to the at least one air outlet. Air from the at least one low-pressure compression cylinder enters the intercooler via the at least one air inlet, is cooled within the plurality of air passage tubes within the central core unit, and then enters the at least one high-pressure compression cylinder via the at least one air outlet. The central core unit, the first manifold and the second manifold are integrally connected by welding to form a single piece.

The at least one cooling water inlet is integrally connected by welding to the central core unit proximal to the first side of the central core unit, the at least one cooling water inlet being in communication with the interior of the central core unit, and the at least one cooling water outlet is integrally connected by welding to the central core unit proximal to the second side of the central core unit, the at least one cooling water outlet being in communication with the interior of the central core unit.

The interior of the central core unit is adapted to receive cooling water from a supply via the at least one cooling water inlet and return the cooling water to the supply via the at least one cooling water outlet such that the cooling water flows through the interior of the central core unit so as to pass over the plurality of air passage tubes. Air passes from the first manifold to the second manifold via the plurality of air passage tubes within the interior of the central core unit so as to be cooled by the water flowing through the interior of the central core unit and passing over the plurality of air passage tubes. Preferably, the cooling water supply is an engine cooling water supply and the central core unit, the first manifold and the second manifold are constructed from aluminum.

The at least one air inlet includes an inlet conduit integrally connected by welding to the first manifold, the inlet conduit being in communication with an interior portion of the first manifold, and an inlet mounting plate integrally connected by welding to the inlet conduit. Preferably, the inlet conduit and the inlet mounting plate are constructed from aluminum, the at least one low-pressure compression cylinder includes two low-pressure compression cylinders and the at least one air inlet includes two air inlets.

The first manifold has a width greater than a width of the central core unit such that the first manifold extends along the first side past the third and fourth sides of the central core unit, whereby a surface of the first manifold oriented toward the central core unit has exposed portions adjacent to each of the third and fourth sides of the central core unit, and the air inlets are disposed on the surface of the first manifold such that the inlet conduits are each integrally connected to an exposed portion of the surface of the first manifold adjacent to each of the third and fourth sides of the central core unit.

The at least one air outlet includes an outlet conduit integrally connected by welding to the second manifold, the outlet conduit being in communication with an interior portion of the second manifold, and an outlet mounting plate integrally connected by welding to the outlet conduit. Preferably, the outlet conduit and the outlet mounting plate are constructed from aluminum. The second manifold includes a raised central portion, the outlet conduit being integrally connected to the raised central portion of the second manifold.

In a further aspect of the present invention, a method of producing a single piece water over air intercooler is provided. The method includes the steps of providing aluminum plates corresponding to first, second, third, fourth, fifth and sixth sides of a central core unit, integrally connecting a plurality of air passage tubes to a surface of the first and second sides such that the tubes are sealed with respect to the surface of the first and second sides and are in communication with an opposing surface of the first and second sides, providing at least one cooling water inlet and at least one cooling water outlet, integrally connecting the at least one cooling water inlet and the at least one cooling water outlet to a surface of the fifth side by welded connections such that the at least one cooling water inlet and the at least one cooling water outlet are in communication with an opposing surface of the fifth side, integrally connecting the first, second, third, fourth, fifth and sixth sides by welded connections to form a central core unit having a box structure defining a sealed interior portion therein, wherein the air passage tubes are contained within the sealed interior portion of the central core unit and are in communication with an exterior of the central core unit at the first and second sides and wherein the at least one cooling water inlet and the at least one cooling water outlet are disposed on the exterior of the central core unit, providing an aluminum first manifold, integrally connecting the first manifold to the central core unit at the first side by a welded connection such that an interior portion of the first manifold is sealed with respect to the central core unit and is in communication with the plurality of air passage tubes, providing an aluminum second manifold, integrally connecting the second manifold to the central core unit at the second side by a welded connection such that an interior portion of the second manifold is sealed with respect to the central core unit and is in communication with the plurality of air passage tubes, providing at least one aluminum air inlet conduit and at least one aluminum inlet mounting bracket, the at least one inlet mounting bracket being adapted to connect the intercooler to a reciprocating air compressor, integrally connecting the at least one air inlet conduit to the first manifold by a welded connection such that the at least one air inlet conduit is sealed with respect to the first manifold and is in communication with the interior portion of the first manifold, integrally connecting the at least one inlet mounting bracket to the at least one air inlet conduit by a welded connection, providing at least one aluminum air outlet conduit and at least one aluminum outlet mounting bracket, the at least one outlet mounting bracket being adapted to connect the intercooler to the reciprocating air compressor, integrally connecting the at least one air outlet conduit to the second manifold by a welded connection such that the at least one air outlet conduit is sealed with respect to the second manifold and is in communication with the interior portion of the second manifold, and integrally connecting the at least one outlet mounting bracket to the at least one air outlet conduit by a welded connection.

Further details and advantages of the invention will become clear upon reading the following detailed description in conjunction with the accompanying drawing figures, wherein like parts are designated with like reference numerals throughout.

### BRIEF DESCRIPTION OF THE DRAWINGS

FIG. 1 diagrammatically depicts a reciprocating air compressor having a single piece water over air intercooler according to an embodiment of the present invention;

FIG. 2 depicts a front view of the single piece water over air intercooler for a reciprocating air compressor according to the embodiment shown in FIG. 1;

FIG. 3 depicts a top plan view of the single piece water over air intercooler shown in FIG. 2;

FIG. 4 depicts a right side view of the single piece water over air intercooler shown in FIG. 2; and

FIG. 5 diagrammatically depicts an interior of a central core unit of the water over air intercooler according to reference lines 5-5 shown in FIG. 4.

### DESCRIPTION OF THE INVENTION

For purposes of the description hereinafter, spatial orientation terms, if used, shall relate to the referenced embodiment as it is oriented in the accompanying drawing figures or otherwise described in the following detailed description. However, it is to be understood that the embodiments described hereinafter may assume many alternative variations and embodiments. It is also to be understood that the specific devices illustrated in the accompanying drawing figures and described herein are simply exemplary and should not be considered as limiting.

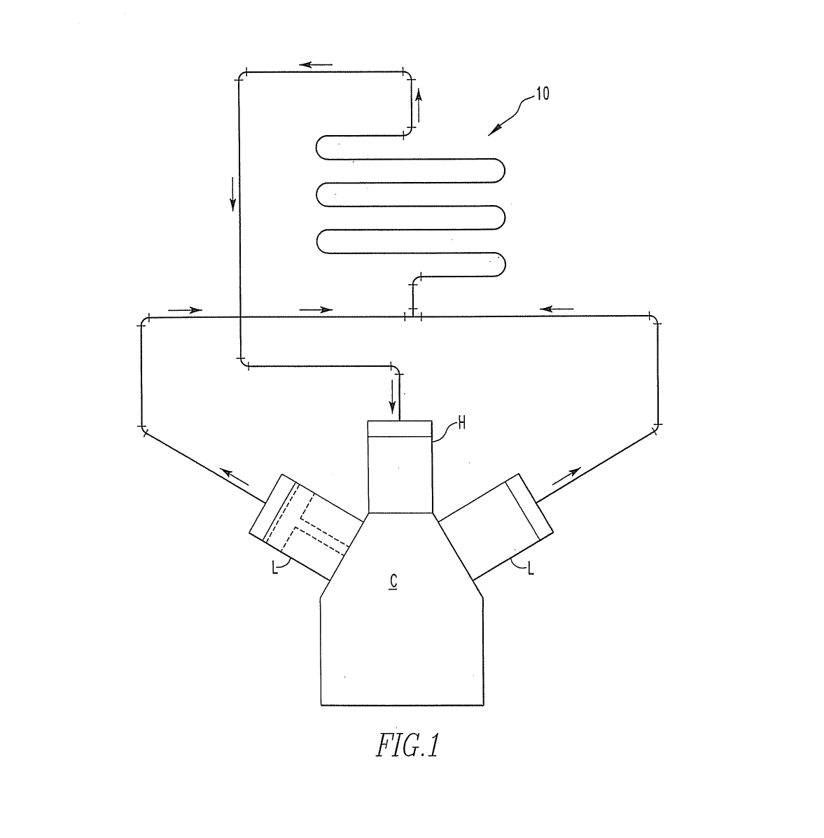

FIG. 1 illustrates a reciprocating air compressor C having a single piece water over air intercooler 10 in accordance with a preferred embodiment of the present invention. As shown in FIG. 1, reciprocating air compressor C is a multi-stage, three-cylinder water cooled compound compressor. The intercooler 10 is attached directly to the compressor C between first and second compression stages, though it is to be appreciated that the intercooler according to the preferred embodiment may be used to cool compressed air before or after any stage of compression. As shown in FIG. 1, the reciprocating air compressor C includes two low pressure compression cylinders L in communication with at least one inlet of the intercooler 10 and a high pressure compression cylinder H in communication with at least one outlet of the intercooler 10.

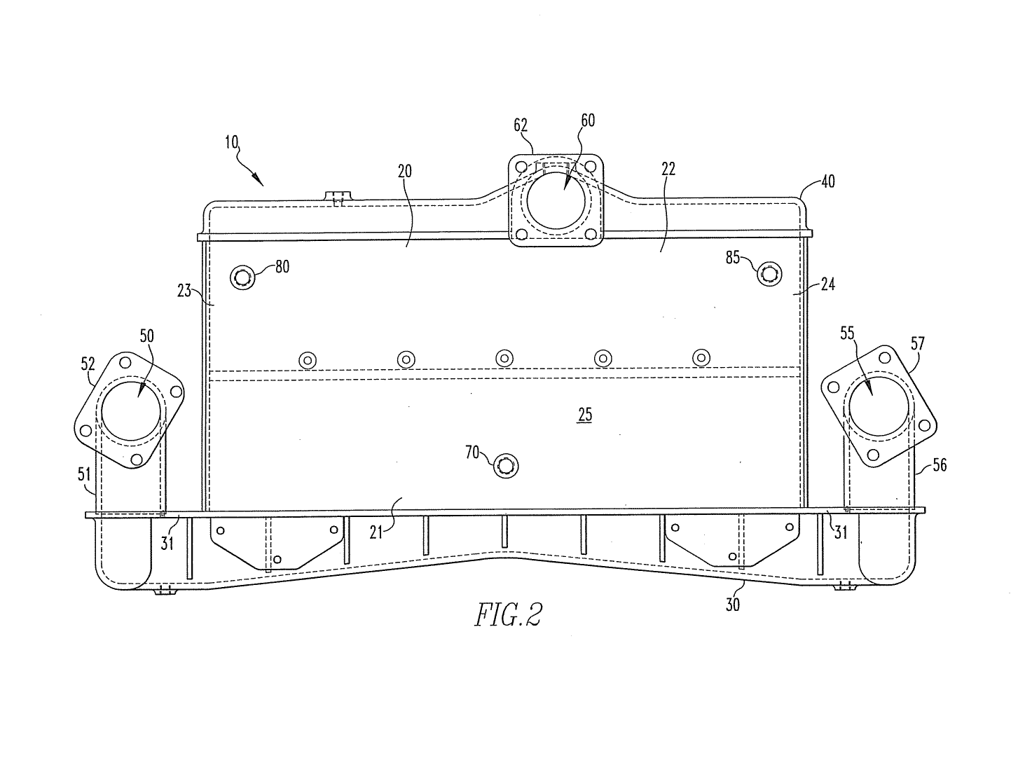

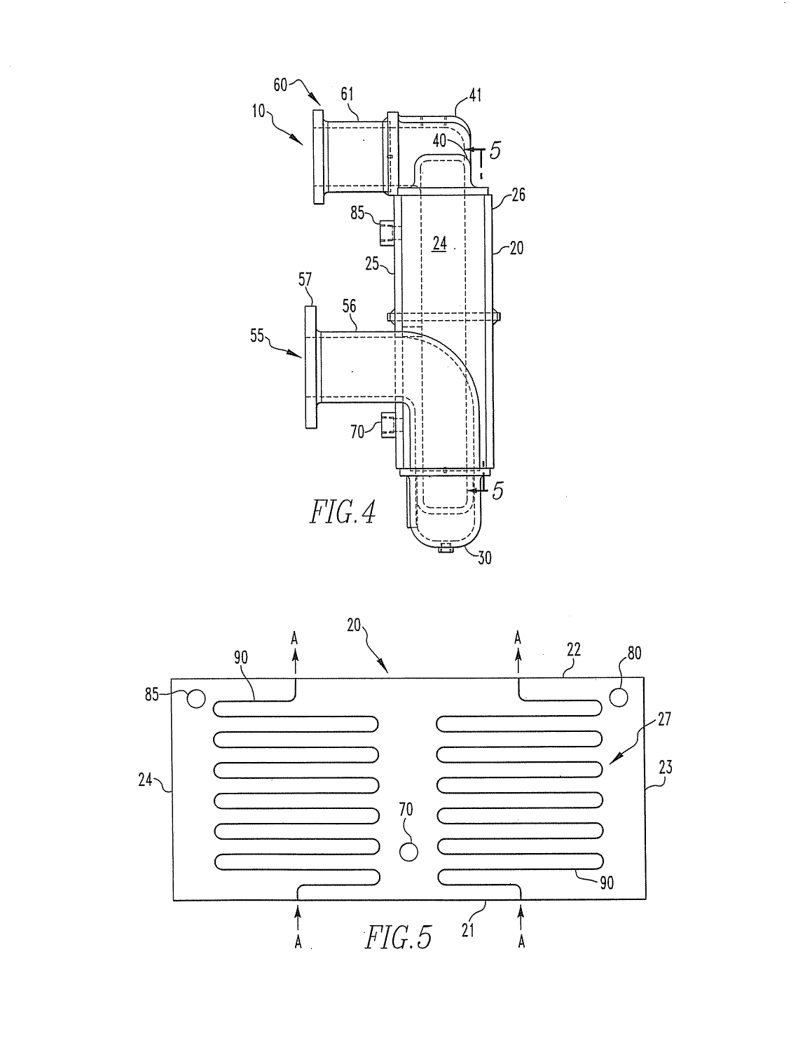

FIG. 2 depicts a front view of the single piece water over air intercooler in accordance with a preferred embodiment of the present invention. As shown in FIG. 2, the intercooler 10 includes a central core unit 20 having a box-type shape with a first or bottom side 21, a second or top side 22, a third side 23, a fourth side 24, a fifth or front side 25, and a sixth or back side 26 (shown in FIG. 4). The sides 21, 22, 23, 24, 25, 26 of the central core unit 20 are constructed of aluminum and are integrally connected by weld connections to form the box-type structure of the central core unit 20 with an interior 27 (shown in FIG. 5).

The central core unit 20 includes a cooling water inlet 70 integrally connected to the front side 25 of the central core unit 20 proximate to the bottom side 21 of the central core unit 20 and in communication with the interior 27 of the central core unit 20. The cooling water inlet 70 is connected to a cooling water supply (not shown), which is preferably the cooling water supply for the vehicle's engine. Cooling water from the cooling water supply enters the interior 27 of the central core unit 20 via the cooling water inlet so as to substantially fill the interior 27 with water and generate a flow of cooling water within the central core unit 20.

The central core unit 20 also includes two cooling water outlets 80, 85 integrally connected to the front side 25 of the central core unit 20 proximate to the top side 22 and in communication with the interior 27 of the central core unit. The cooling water outlets are disposed opposite one another on the front side 25 of the central core unit 20. The cooling water outlets 80, 85 are connected to the cooling water supply as well so as to return cooling water that has flowed upward through the interior 27 of the central core unit 20 from the cooling water inlet 70 back to the cooling water supply. As can be appreciated, water will flow into the interior 27 from the cooling water inlet 70 and up through the interior 27 of the central core unit 20 and then out of the interior 27 via the cooling water outlets 80, 85.

As shown in FIG. 5, which illustrates the interior 27 of the central core unit 20 from the rear of the central core unit 20 according to reference lines 5-5 in FIG. 4, the interior 27 of the central core unit 20 includes multiple radiator-type air passage tubes 90 for the passage of air from the bottom side 21 of the central core unit 20 to the top side 22 of the central core unit 20, as indicated by arrows “A” shown in FIG. 5. Air passage tubes 90 are spaced apart by aluminum cooling fins (not shown). Such tubes are well-known to those of ordinary skill in the art and are depicted diagrammatically for purposes of illustration only. Such tubes are typically constructed of cast iron, though they may be made of any material, including aluminum, known by those of ordinary skill in the art to be suitable for such purposes. It is to be appreciated that the number and configuration of the air passage tubes 90 contained within the interior 27 of the central core unit 20 may be of any number or configuration known by those of ordinary skill in the art to be suitable for such purposes.

As shown in FIG. 2, a first manifold 30 is integrally attached to the bottom side 21 of the central core unit 20 by welding. An interior portion (not shown) of the first manifold 30 is in communication with the air passage tubes 90 contained within the interior 27 of the central core unit 20. First manifold 30 has a width greater than the width of the central core unit 20 such that the first manifold 30 extends past the central core unit on both the third 23 and fourth 24 sides, thus exposing surface portions 31 at the ends of the first manifold 30, which are oriented upward or toward the central core unit 20, adjacent to both the third 23 and fourth 24 sides of the central core unit 20. First manifold 30 is constructed from aluminum and may include drainage ports on a bottom surface thereof so as to allow condensate forming within an interior portion of the first manifold to be drained from the first manifold 30 during regular maintenance operations.

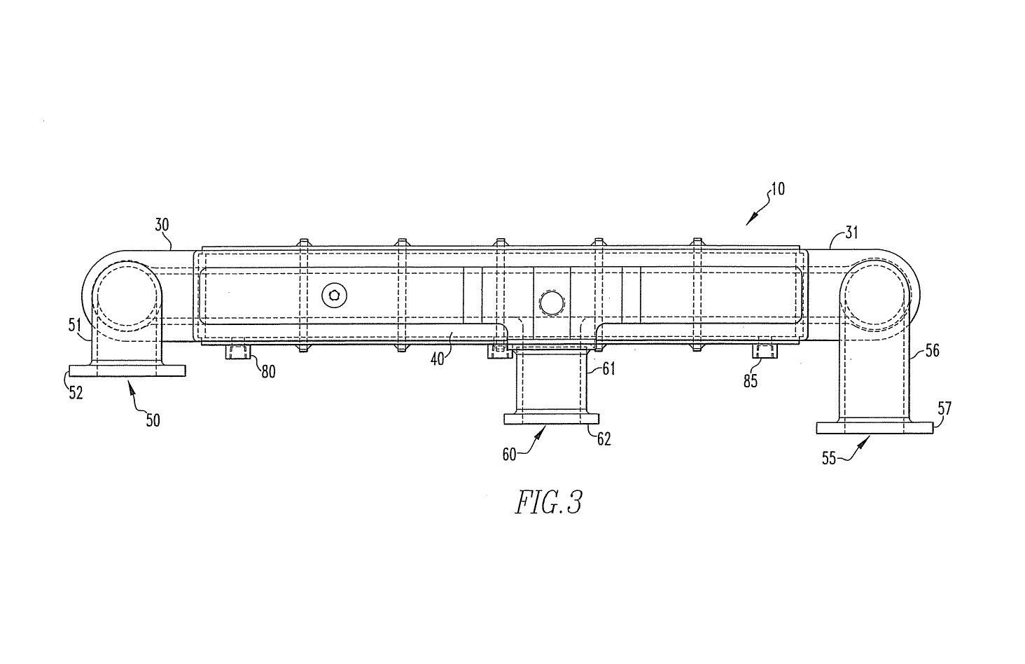

First 50 and second 55 air inlets are disposed on the exposed surfaces 31 of the first manifold 30 and communicate with the interior of the first manifold 30 so as to allow low pressure air exiting from a first stage of compression to enter into the first manifold 30. The first 50 and second 55 air inlets include first 51 and second 56 air inlet conduits, respectively. The air inlet conduits 51, 56 are constructed from aluminum and are integrally connected to the exposed surfaces 31 of the first manifold 30 by welding at positions adjacent to the third 23 and fourth 24 sides of the central core unit 20, respectively. As shown in FIGS. 3 and 4, the first 51 and second 56 air inlet conduits are curved pipes that extend upward from the exposed surfaces 31 of the first manifold 30 and away from the front side 25 of the central core unit 20. Preferably, two air inlets 50, 55 are provided so as to allow air compressed by two separate low pressure compression cylinders L (shown in FIG. 1) in a first stage of compression to be cooled by a common intercooler device 10. It is to be appreciated, though, that a different number of air inlets may be provided without departing from the scope of the present invention.

As shown in FIGS. 2-4, first 52 and second 57 air inlet mounting brackets, constructed from aluminum, are integrally connected to the first 51 and second 56 air inlet conduits by welding. The inlet mounting brackets 52, 57 are rectangular plates that allow the intercooler 10 to be bolted directly into the compressor system. The mounting brackets 52, 57 are sized and configured so as to use the same interface positions as existing intercoolers, thus the intercooler 10 can be used as a replacement part for existing compressor systems as well as with newly manufactured compressor systems. The mounting brackets 52, 57 include large central holes so as to allow air exiting from the first stage of compression to pass into and through the air inlet conduits 51, 56.

As shown in FIG. 2, a second manifold 40 is integrally attached to the top side 22 of the central core unit 20 by welding. An interior portion (not shown) of the second manifold 40 is in communication with the passage tubes 90 contained within the interior 27 of the central core unit 20. Second manifold 40 includes a raised central portion 41. Second manifold 40 is constructed from aluminum and may include a port on a top surface thereof over the raised central portion 41 so that a pressure relief valve assembly can be attached to the intercooler 10.

An air outlet 60 is disposed on the raised central portion 41 of the second manifold 40 and communicates with the interior of the second manifold 40 so as to allow cooled low pressure air exiting from the central core unit 20 and the second manifold 40 to enter into a second stage of compression. The air outlet 60 includes an air outlet conduit 61. The air outlet conduit 61 is constructed from aluminum and is integrally connected to the raised central portion 41 of the second manifold 40 by welding. As shown in FIGS. 3 and 4, the air outlet conduit 61 is a straight section of pipe that extends outward from the raised central portion 41 of the second manifold 40 and away from the front side 25 of the central core unit 20. Preferably, one air inlet 60 is provided so as to allow air cooled within the central core unit 20 to pass into a single high pressure compression cylinder H (shown in FIG. 1) in a second stage of compression. It is to be appreciated, though, that a different number of air outlets may be provided without departing from the scope of the present invention.

As shown in FIGS. 2-4, an air outlet mounting bracket 62, constructed from aluminum, is integrally connected to the air outlet conduit 61 by welding. The outlet mounting bracket 62 is a rectangular plate that allows the intercooler 10 to be bolted directly into the compressor system. The outlet mounting bracket 62 is sized and configured so as to use the same interface positions as existing intercoolers, thus the intercooler 10 can be used as a replacement part for existing compressor systems as well as with newly manufactured compressor systems. The outlet mounting bracket 62 includes a large central hole so as to allow air exiting from the intercooler 10 to pass through and out of the air outlet conduit 61.

With reference to FIGS. 2-5, the operation of the single piece intercooler 10 will now be described in detail. The intercooler 10 is directly attached to a reciprocating air compressor having multiple stages of compression by bolting the first 52 and second 57 inlet mounting brackets and the outlet mounting bracket 62 to the compressor at the appropriate interface positions. Intercooler 10 is also connected to the engine's cooling water supply at the cooling water inlet 70 and the first 80 and second 85 cooling water outlets. Cooling water is then caused to flow into the interior 27 of the central cooling unit 20 until it substantially fills the interior 27. The cooling water then returns to the engine's cooling water supply via the first 80 and second 85 cooling water outlets, thus creating a flow of cooling water through the interior 27 of the central core unit 20 and over the plurality of air passage tubes 90 contained within the interior 27 of the central core unit 20.

Low-pressure, compressed air is received from the compression cylinders responsible for subjecting the air to the first stage of compression in the compressor C via the first 50 and second 55 air inlets. Air then passes into an interior portion of the first manifold 30 via the first 51 and second 56 air inlet conduits. As low-pressure compressed air collects within the first manifold 30, the air passes upward into the plurality of air passage tubes 90 contained within the interior 27 of the central core unit 20 at the first side 21 of the central core unit 20. As the air passes upward through the air passage tubes 90 contained within the interior 27 of the central core unit 20, water flowing through the interior 27 flows over the air passage tubes 90 and attached aluminum fins, thus causing the air within the tubes 90 to be cooled to near the ambient temperature of the water.

Cooled air then exits the air passage tubes 90 at the second side 22 of the central core unit 20 and collects in the second manifold 40. As the air collects within the second manifold 40, the air passes into the air outlet conduit 61 and out of the intercooler 10 to the compression cylinder responsible for subjecting the air to the second stage of compression in the compressor via the air outlet 60.

The components of the intercooler 10, including the central core unit 20, first manifold 30, second manifold 40, first inlet conduit 51, second inlet conduit 56, first inlet mounting plate 52, second inlet mounting plate 57, outlet conduit 61, outlet mounting plate 62, cooling water inlet 70, and first 80 and second 85 cooling water outlets, are welded together according to techniques known to those of ordinary skill in the art so as to create a single, unitary piece. Such a unitary design reduces the potential for leakage of compressed air from the intercooler 10 as well as the potential for mixing of the compressed air with cooling water within the intercooler 10 by sealing the connections between the various components. Preferably, the components of the intercooler 10 are constructed from aluminum so as to realize weight reductions in comparison to prior art intercoolers. The intercooler 10 also retains common interface positions, thus the intercooler 10 can be used as a replacement part in a variety of compressor models.

With reference to FIGS. 2-5 the process for manufacturing the single piece water over air intercooler 10 in accordance with a preferred embodiment of the present invention will be described in detail. Aluminum plates corresponding to the first 21, second 22, third 23, fourth 24, fifth 25 and sixth 26 sides of the central core unit 20 are provided. A plurality of air passage tubes 90 is integrally connected to a surface of the first 21 and second 22 sides such that the tubes 90 are sealed with respect to the surfaces and are in communication with opposing surfaces of the first 21 and second 22 sides. Cooling water inlet 70 and two cooling water outlets 80, 85 are integrally connected to a surface of the fifth side 25 by welded connections so as to be in communication with an opposing surface of the fifth side 25. The first 21, second 22, third 23, fourth 24, fifth 25 and sixth 26 sides of the central core unit 20 are then integrally connected by a welded connection to form a box structure defining a sealed interior portion 27 therein. The air passage tubes 90 are contained within the sealed interior portion 27 of the central core unit 20 and in communication with an exterior of the central core unit 20 at the first 21 and second 22 sides. The cooling water inlet 70 and the cooling water outlets 80, 85 are disposed on the exterior of the central core unit 20.

A first manifold 30 constructed from aluminum is then integrally connected to the first side 21 of the central core unit 20 by a welded connection so that an interior portion of the first manifold 30 is sealed with respect to the central core unit 20 and is in communication with the plurality of air passage tubes 90 within the interior 27 of the central core unit 20. A second manifold 40 constructed from aluminum is then integrally connected to the second side 22 of the central core unit 20 by a welded connection so that an interior portion of the second manifold 40 is sealed with respect to the central core unit 20 and is in communication with the plurality of air passage tubes 90 within the interior 27 of the central core unit 20.

Air inlet conduits 51, 56, constructed from aluminum, are integrally connected to the first manifold 30 by welded connections so that the air inlet conduits 51, 56 are sealed with respect to the first manifold 30 and are in communication with the interior portion of the first manifold 30. Inlet mounting brackets 52, 57, constructed from aluminum, are then integrally connected to the air inlet conduits 51, 56, respectively, by welded connections for connecting the intercooler 10 to a reciprocating air compressor C. An air outlet conduit 61, constructed from aluminum, is integrally connected to the second manifold 40 by a welded connection so that the air outlet conduit 61 is sealed with respect to the second manifold 40 and is in communication with the interior portion of the second manifold 40. An outlet mounting bracket 62, constructed from aluminum, is then integrally connected to the air outlet conduit 61 by a welded connection for connecting the intercooler 10 to a reciprocating air compressor.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention which is to be given the full breadth of the appended claims and any and all equivalents thereof.

The invention claimed is:

1. A water over air intercooler for use in a reciprocating air compressor, said water over air intercooler comprising:
a central core unit, said central core unit having opposing first and second sides, opposing third and fourth sides and opposing fifth and sixth sides, said sides being integrally connected to define an interior within said central core unit, said central core unit containing a plurality of air passage tubes within said interior, said central core unit having at least one cooling water inlet and at least one cooling water outlet disposed thereon;
a first manifold disposed on said first side of said central core unit, said first manifold having at least one air inlet disposed thereon, said first manifold being in communication with said plurality of air passage tubes so as to receive air from said at least one air inlet and direct the air to said plurality of air passage tubes; and
a second manifold disposed on said second side of said central core unit, said second manifold having at least one air outlet disposed thereon, said second manifold being in communication with said plurality of air passage tubes so as to receive air from said plurality of finned air passage tubes and direct the air to said at least one air outlet,
wherein said central core unit, said first manifold and said second manifold are integrally connected by welding to form a single piece.

2. The water over air intercooler according to claim 1, wherein
said at least one cooling water inlet is integrally connected by welding to said central core unit proximal to said first side of said central core unit, said at least one cooling water inlet being in communication with said interior of said central core unit, and
said at least one cooling water outlet is integrally connected by welding to said central core unit proximal to said second side of said central core unit, said at least one cooling water outlet being in communication with said interior of said central core unit.

3. The water over air intercooler according to claim 2, wherein said interior of said central core unit is adapted to receive cooling water from a supply via said at least one cooling water inlet and return the cooling water to the supply via said at least one cooling water outlet such that the cooling water flows through said interior of said central core unit so as to pass over said plurality of air passage tubes.

4. The water over air intercooler according to claim 3, wherein air passes from said first manifold to said second manifold via said plurality of air passage tubes within said interior of said central core unit so as to be cooled by the water flowing through said interior of said central core unit and passing over said plurality of air passage tubes.

5. The water over air intercooler according to claim 3, wherein the cooling water supply is an engine cooling water supply.

6. The water over air intercooler according to claim 1, wherein said central core unit, said first manifold and said second manifold are constructed from aluminum.

7. The water over air intercooler according to claim 1, wherein said at least one air inlet is adapted to receive compressed air from a first stage of compression.

8. The water over air intercooler according to claim 1, wherein said at least one air inlet comprises an inlet conduit integrally connected by welding to said first manifold, said inlet conduit being in communication with an interior portion of said first manifold, and an inlet mounting plate integrally connected by welding to said inlet conduit.

9. The water over air intercooler according to claim 8, wherein said inlet conduit and said inlet mounting plate are constructed from aluminum.

10. The water over air intercooler according to claim 8, wherein said at least one air inlet comprises two air inlets.

11. The water over air intercooler according to claim 10, wherein
said first manifold has a width greater than a width of said central core unit such that said first manifold extends along said first side past said third and fourth sides of said central core unit, whereby a surface of said first manifold oriented toward said central core unit has exposed portions adjacent to each of said third and fourth sides of said central core unit, and
said air inlets are disposed on said surface of said first manifold such that said inlet conduits are each integrally connected to an exposed portion of said surface of said first manifold adjacent to each of said third and fourth sides of said central core unit.

12. The water over air intercooler according to claim 1, wherein said at least one air outlet is adapted to direct compressed air to a second stage of compression.

13. The water over air intercooler according to claim 1, wherein said at least one air outlet comprises an outlet conduit integrally connected by welding to said second manifold, said outlet conduit being in communication with an interior portion of said second manifold, and an outlet mounting plate integrally connected by welding to said outlet conduit.

14. The water over air intercooler according to claim 13, wherein said outlet conduit and said outlet mounting plate are constructed from aluminum.

15. The water over air intercooler according to claim 13, wherein said second manifold comprises a raised central portion, said outlet conduit being integrally connected to said raised central portion of said second manifold.

16. A reciprocating air compressor having multiple stages of compression, said reciprocating air compressor comprising:
at least one low-pressure compression cylinder in a first stage of compression;
at least one high-pressure compression cylinder in a second stage of compression; and
a water over air intercooler in communication with said at least one low-pressure compression cylinder and said at least one high-pressure compression cylinder, said intercooler comprising:
a central core unit, said central core unit having opposing first and second sides, opposing third and fourth sides and opposing fifth and sixth sides, said sides being integrally connected to define an interior within said central core unit, said central core unit containing a plurality of air passage tubes within said interior, said central core unit having at least one cooling water inlet and at least one cooling water outlet disposed thereon;
a first manifold disposed on said first side of said central core unit, said first manifold having at least one air inlet disposed thereon, said first manifold being in communication with said plurality of air passage tubes so as to receive air from said at least one air inlet and direct the air to said plurality of air passage tubes; and
a second manifold disposed on said second side of said central core unit, said second manifold having at least one air outlet disposed thereon, said second manifold being in communication with said plurality of air passage tubes so as to receive air from said plurality of finned air passage tubes and direct the air to said at least one air outlet,
wherein air from said at least one low-pressure compression cylinder enters said intercooler via said at least one air inlet, is cooled within said plurality of air passage tubes within said central core unit, and then enters said at least one high-pressure compression cylinder via said at least one air outlet, and
wherein said central core unit, said first manifold and said second manifold are integrally connected by welding to form a single piece.

17. The reciprocating air compressor according to claim 16, wherein
said at least one cooling water inlet is integrally connected by welding to said central core unit proximal to said first side of said central core unit, said at least one cooling water inlet being in communication with said interior of said central core unit, and
said at least one cooling water outlet is integrally connected by welding to said central core unit proximal to said second side of said central core unit, said at least one cooling water outlet being in communication with said interior of said central core unit.

18. The reciprocating air compressor according to claim 17, wherein said interior of said central core unit is adapted to receive cooling water from a supply via said at least one cooling water inlet and return the cooling water to the supply via said at least one cooling water outlet such that the cooling water flows through said interior of said central core unit so as to pass over said plurality of air passage tubes.

19. The reciprocating air compressor according to claim 18, wherein air passes from said first manifold to said second manifold via said plurality of air passage tubes within said interior of said central core unit so as to be cooled by the water flowing through said interior of said central core unit and passing over said plurality of air passage tubes.

20. The reciprocating air compressor according to claim 18, wherein the cooling water supply is an engine cooling water supply.

21. The reciprocating air compressor according to claim 16, wherein said central core unit, said first manifold and said second manifold are constructed from aluminum.

22. The reciprocating air compressor according to claim 16, wherein said at least one air inlet comprises an inlet conduit integrally connected by welding to said first manifold, said inlet conduit being in communication with an interior portion of said first manifold, and an inlet mounting plate integrally connected by welding to said inlet conduit.

23. The reciprocating air compressor according to claim 22, wherein said inlet conduit and said inlet mounting plate are constructed from aluminum.

24. The reciprocating air compressor according to claim 22, wherein said at least one low-pressure compression cylinder comprises two low-pressure compression cylinders and said at least one air inlet comprises two air inlets.

25. The reciprocating air compressor according to claim 24, wherein
said first manifold has a width greater than a width of said central core unit such that said first manifold extends along said first side past said third and fourth sides of said central core unit, whereby a surface of said first manifold oriented toward said central core unit has exposed portions adjacent to each of said third and fourth sides of said central core unit, and
said air inlets are disposed on said surface of said first manifold such that said inlet conduits are each integrally connected to an exposed portion of said surface of said first manifold adjacent to each of said third and fourth sides of said central core unit.

26. The reciprocating air compressor according to claim 16, wherein said at least one air outlet comprises an outlet conduit integrally connected by welding to said second manifold, said outlet conduit being in communication with an interior portion of said second manifold, and an outlet mounting plate integrally connected by welding to said outlet conduit.

27. The reciprocating air compressor according to claim 26, wherein said outlet conduit and said outlet mounting plate are constructed from aluminum.

28. The reciprocating air compressor according to claim 26, wherein said second manifold comprises a raised central portion, said outlet conduit being integrally connected to said raised central portion of said second manifold.

29. A method of producing a single piece water over air intercooler, said method comprising the steps of:
providing aluminum plates corresponding to first, second, third, fourth, fifth and sixth sides of a central core unit;
integrally connecting a plurality of air passage tubes to a surface of said first and second sides such that said tubes are sealed with respect to said surface of said first and second sides and are in communication with an opposing surface of said first and second sides;
providing at least one cooling water inlet and at least one cooling water outlet;
integrally connecting said at least one cooling water inlet and said at least one cooling water outlet to a surface of said fifth side by welded connections such that said at least one cooling water inlet and said at least one cooling water outlet are in communication with an opposing surface of said fifth side;
integrally connecting said first, second, third, fourth, fifth and sixth sides by welded connections to form a central core unit having a box structure defining a sealed interior portion therein, wherein said air passage tubes are contained within said sealed interior portion of said central core unit and are in communication with an exterior of said central core unit at said first and second sides and wherein said at least one cooling water inlet and said at least one cooling water outlet are disposed on said exterior of said central core unit;
providing an aluminum first manifold;
integrally connecting said first manifold to said central core unit at said first side by a welded connection such that an interior portion of said first manifold is sealed with respect to said central core unit and is in communication with said plurality of air passage tubes;
providing an aluminum second manifold;
integrally connecting said second manifold to said central core unit at said second side by a welded connection such that an interior portion of said second manifold is sealed with respect to said central core unit and is in communication with said plurality of air passage tubes;
providing at least one aluminum air inlet conduit and at least one aluminum inlet mounting bracket, said at least one inlet mounting bracket being adapted to connect said intercooler to a reciprocating air compressor;
integrally connecting said at least one air inlet conduit to said first manifold by a welded connection such that said at least one air inlet conduit is sealed with respect to said first manifold and is in communication with said interior portion of said first manifold;
integrally connecting said at least one inlet mounting bracket to said at least one air inlet conduit by a welded connection;
providing at least one aluminum air outlet conduit and at least one aluminum outlet mounting bracket, said at least one outlet mounting bracket being adapted to connect said intercooler to the reciprocating air compressor;
integrally connecting said at least one air outlet conduit to said second manifold by a welded connection such that said at least one air outlet conduit is sealed with respect to said second manifold and is in communication with said interior portion of said second manifold; and
integrally connecting said at least one outlet mounting bracket to said at least one air outlet conduit by a welded connection.
